(19) United States
(12) Patent Application Publication
(10) Pub. No.: US 2023/0164404 A1
(43) Pub. Date: May 25, 2023

(54) ITEM DELIVERY REQUEST BASED ON PROGRAM CONTENT

(71) Applicant: DISH NETWORK L.L.C., Englewood, CO (US)

(72) Inventor: Jesus FLORES GUERRA, Denver, CO (US)

(73) Assignee: DISH NETWORK L.L.C., Englewood, CO (US)

(21) Appl. No.: 17/535,002

(22) Filed: Nov. 24, 2021

(51) Int. Cl. H04N 21/81; H04N 21/478; H04N 21/858; H04N 21/41; H04N 21/4722

(52) U.S. Cl. CPC H04N 21/8186; H04N 21/47815; H04N 21/858; H04N 21/4126; H04N 21/4722

(57) ABSTRACT

A method for ordering one or more physical items having a relationship with a content program. The method includes storing and/or transmitting the content program and metadata identifying the items to a receiver and providing an offer to order the items to a content consumer in a visual and/or audio manner. The method further includes receiving an order request for any or all of the items in response to the offer. The order request is initiated by a signal that is sent to and received by the receiver. The method further includes transmitting the order request to an external server accessible to a vendor of the items. Also included is a system having processors to execute such functions, and a storage medium having instructions to execute such functions.

### BACKGROUND

With the advent of streaming and pay per view technologies, in addition to digital video recorder (DVR) and personal video recorder (PVR) technologies where a viewer can record video in a digital format to a disk drive or other type of storage medium for later playback, it has become commonplace for viewers of content programs to view particular programs at a time preferred by the viewer. Viewers may, for example, choose to record a show according to a predetermined rule, upon seeing an advertisement for the program, or by searching the content provider's content guide. Viewers may also choose to save or record a show that they have been viewing live, for example when the content of the show is such where the viewer may want to review the content at a later time.

Viewers of program content, for example television programs, have many options to choose from. Interactivity between a viewer and the television program may improve a user experience, and can affect a viewer's decision to view a particular program, and/or the viewer's enjoyment obtained from viewing the program. For example, as shown in U.S. Pat. No. 8,430,302, a system may use data to provide particular information on a screen for a user to heed during a television program. While such information may be useful and aid in a user's experience, there is a need for systems that can allow for a more interactive experience where a user can receive items relevant to the program content in an efficient and useful manner.

### SUMMARY

Viewers selecting content programs, such as television shows, often have a particular desire to learn something from such a show. For example, when watching a cooking show, a viewer may be learning techniques on how to cook a specific recipe, and may ultimately be interested in reproducing the recipe.

The present disclosure describes systems, methods and a storage medium for enabling interactive activities for a user of program content. For example, a user may be able to utilize aspects of the instant disclosure to electronically request physical items related to a content program to be delivered to the user's house or other preferred place, thus allowing for an interactive experience when viewing the television program.

One aspect of this disclosure is a computer-implemented method, including storing and/or transmitting the content program and metadata identifying the one or more physical items to a digital content receiver and providing an offer to order the one or more physical items to a content consumer in a visual and/or audio manner. The method may further include receiving an order request for any or all of the at least one physical items in response to the offer, where the order request is initiated by a digital signal from a signal transmitter that is sent to and received by the digital content receiver, and transmitting the order request to an external server accessible to a vendor of the physical items.

Another aspect of this disclosure is a system for ordering one or more physical items having a predetermined relationship with a content program, the system comprising one or more hardware processors programmed to store and/or transmit the content program and metadata identifying the one or more physical items to a memory provided within a digital content receiver and provide an offer to order the one or more physical items to a content consumer in a visual and/or audio manner. The processors are further programmed to receive an order request for any or all of the at least one physical items in response to the offer, where the order request is initiated by a digital signal from a signal transmitter that is sent to and received by the digital content receiver, and transmit the order request to an external server accessible to a vendor of the physical items.

Another aspect of this disclosure is a non-transitory, computer readable storage medium having stored instructions therein which, when executed by one or more processors of an electronic device, cause the processors to store and/or transmit the content program and metadata identifying the one or more physical items to a memory provided within a digital content receiver and provide an offer to order the one or more physical items to a content consumer in a visual and/or audio manner. The processors are further programmed to receive an order request for any or all of the at least one physical items in response to the offer, where the order request is initiated by a digital signal from a signal transmitter that is sent to and received by the digital content receiver, and transmit the order request to an external server accessible to a vendor of the physical items.

### BRIEF DESCRIPTION OF THE DRAWINGS

FIG. 1 shows a block diagram of a system for retrieving items according to one or more embodiments.

FIGS. 2A, 2B, 2C and 2D are diagrams illustrating a user utilizing the system for retrieving items according to one or more embodiments.

FIGS. 3A, 3B, 3C and 3D are diagrams illustrating a user illustrating the system for retrieving items according to one or more embodiments.

FIG. 4 is a flow chart illustrating an example method for retrieving items according to one or more embodiments.

### DETAILED DESCRIPTION OF EMBODIMENTS

In the following description, numerous details are set forth to provide an understanding of the present disclosure. However, it may be understood by those skilled in the art that the methods of the present disclosure may be practiced without these details and that numerous variations or modifications from the described embodiments may be possible.

The following definitions are provided in order to aid those skilled in the art in understanding the detailed description.

The term “metadata,” as used herein, describes any type of data that provides information about other data, but not information about the content of the data itself.

The term “content receiver” as used herein includes any type of receiver that is utilized by a user to receive and present content from a content provider, such as a satellite, cable television, on-demand (streaming or otherwise) provider, pay per view programming provider, or the like. Exemplary content receivers include, but are not limited to, television receivers, set top boxes, digital video recorders, digital video disk (DVD) players and personal computers.

The term “content program” as used herein includes any video, audio or video and audio program that can be provided to a user (e.g., a viewer or a listener, or both) by virtue of the content receiver. The content program may be viewed on a display screen such as a television screen, a computer screen, a tablet screen, or the like.

The term “digital signal,” as used herein, includes a means of conveying an instruction from one medium to another (including but not limited to a remote control to a digital video recorder, or a digital video recorder to a smartphone), whereby the transfer of information occurs at least partially using digital technology.

The term “user” refers to one who utilizes the systems and methods of the embodiments described herein. The user may be a viewer of a content program, for example, one who watches a video television program. In this sense, the term “viewer” and the term “user” are used interchangeably. However, each term is also intended to encompass a situation where the user (viewer) uses, listens to, or otherwise operates content that is not entirely in video form, such as audio content or a combination of audio and video content. Further, the term “user” and “content consumer” are used interchangeably herein to reference one who uses and/or consumes the content being referenced in this disclosure.

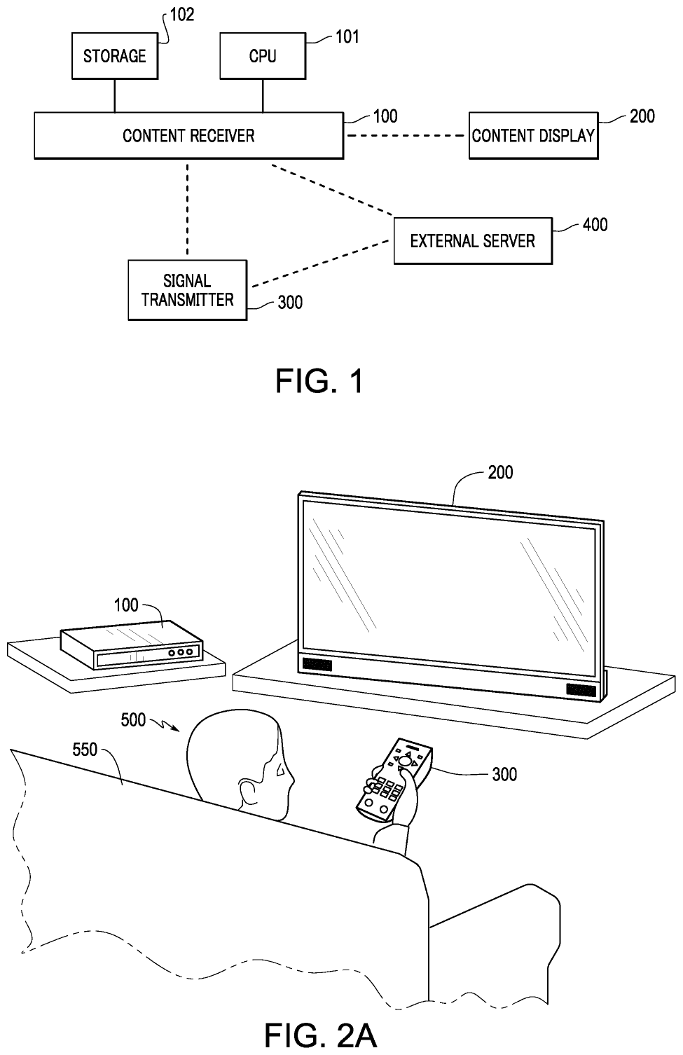

FIG. 1 shows a system according to some embodiments of the instant disclosure. Shown is a content receiver 100, examples of which have been described heretofore. While any content receiver within the scope of the term may be used with reference to the system of FIG. 1, a DVR is used herein as a nonlimiting example. The content receiver 100 may be provided to the user by a content provider. The content receiver may correspond to a set-top box, which can communicate with one or more of a content display 200, signal transmitter 300 and external server 400. All of the content receiver 100 content display 200, signal transmitter 300 and external server 400 (together considered “components”) may be connected via a single network to allow for communication between each component, or there may be included connections through individual components or a series of components through one or more local area network or other network (for example, a wide area network), Bluetooth or other form of near-field or other communication.

The content receiver may allow for the user to watch a content program “live” (e.g., at a prescribed time as set by the content provider, which may be a television network or other entity) or “on demand” (e.g., at a time determined by the user). In a situation where the content program is to be viewed on demand, a user may schedule the content receiver 100 to record the program at the time that it is scheduled to be broadcast by the content provider, and the program can remain stored on the content receiver 100 for a predetermined amount of time. Alternatively, the program may be prestored on the content receiver 100 by being downloaded from a streaming service or from the content provider via the internet using TCP/IP protocol or other available methods. Still further, the program can be stored on the internet or on a server remote from the content receiver 100, and may be available for direct download to the user's television, computer, tablet and the like.

The content receiver 100 may include one or more processing units 101 and one or more non-transitory storage media 102. The one or more non-transitory storage media may take the form of a magnetic storage medium, optical storage medium, magneto-optical storage medium, read only memory, random access memory, erasable program memory, flash memory and the like. The one or more processing units 101 may include hardware processors such as a central processing unit and may be configured to perform the steps of identifying and/or storing (either in the storage media 102 or other storage component such as another memory within the content receiver 100) a list of at least one item having a predetermined relationship with a content program, displaying a request for a digital signal on a display screen at a predetermined time, and upon receipt of the digital signal, transmitting, to an external server, a request for retrieval of the at least one item.

In embodiments where a content receiver 100 is used, the content receiver 100 is connected to the content display 200. The connection may be wired or wireless, and/or through a local area network or other network (for example, a wide area network), Internet, Bluetooth or other near-field or other communication. The content display 200 may be a television, a laptop, a tablet, or any other device that may play audio and/or video content and may be capable of displaying the content program. The content display 200 may include a display screen that will allow the user to visually view, for example, a video portion of the content program.

In some embodiments, the content display 200 will also include a speaker or other audio transmitter to allow for audio portions of the content program to be communicated to the user. That is, the content program may include an audio component that is played by the speaker or other audio transmitter, which can allow for the content to be heard by the user or other consumer of the content.

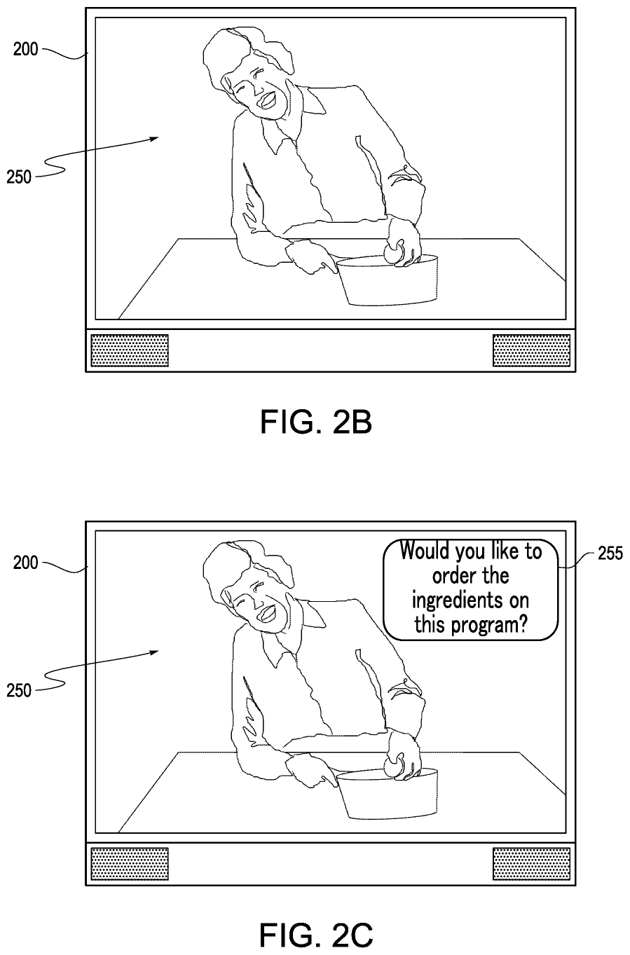

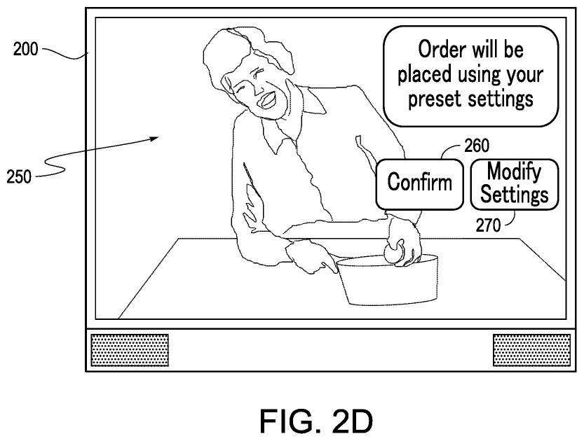

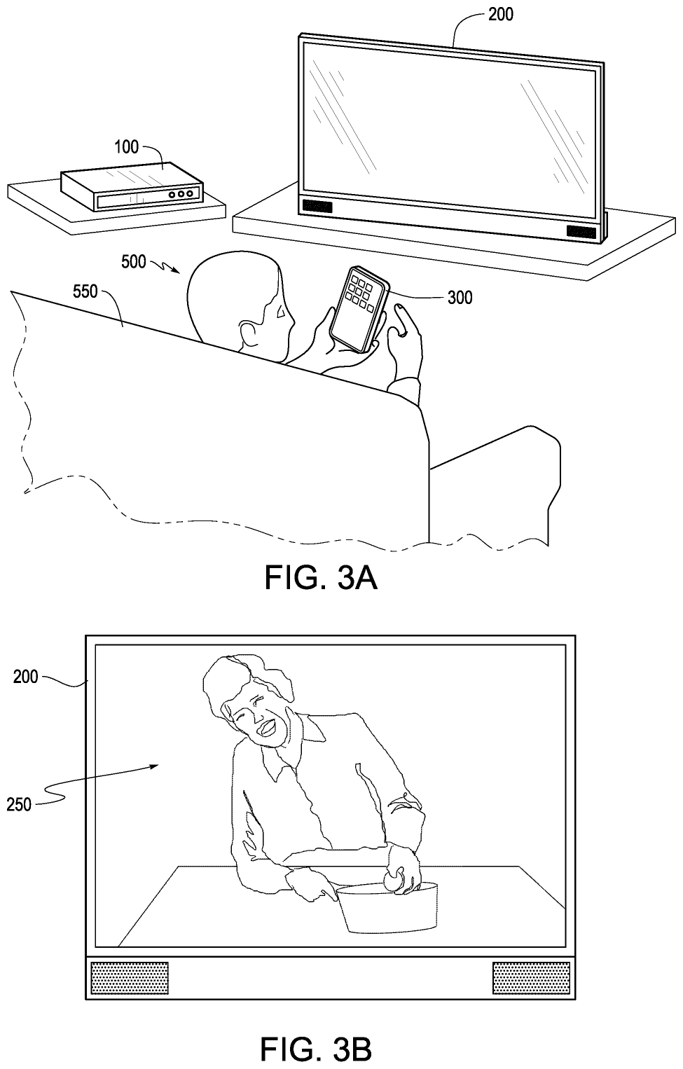

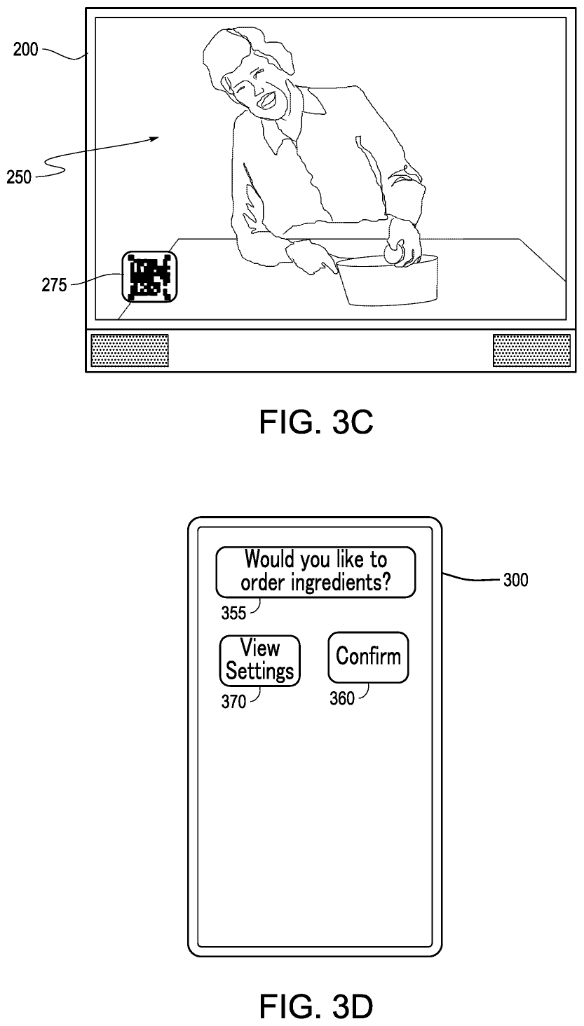

Referring still to FIG. 1, a signal transmitter 300 is provided. The signal transmitter 300 may be utilized by a user to communicate with the content receiver 100 and/or directly with an external server 400. The connections to allow for communication between the signal transmitter 200 and content receiver 300 and/or external server 400 may be wired or wireless, and/or through a local area network or other network (for example, a wide area network), Bluetooth or other near field communication. In some embodiments, and as further described with reference to FIGS. 2A-2D, the signal transmitter 300 is a remote control or other item operated by a user that will directly transmit a signal to the content receiver 100, which will in turn transmit information to the external server 400. In some embodiments, as described with reference to FIGS. 3A-3D, the signal transmitter 300 is a smartphone or other portable device that may communicate with the content receiver 100 and may also be capable of directly transmitting a signal to the external server 400.

FIG. 2A shows a non-limiting exemplary embodiment of the instant disclosure. FIG. 2A includes a diagram of user 500 sitting, for example, on a chair 550 in a room. The user 500 is able to watch content on a television (an exemplary content display 200), the content display being connected to a DVR (the exemplary content receiver 100). The user has access to a remote (an exemplary signal transmitter 300).

While FIG. 2A shows the user 500 on the chair 550, the instant disclosure is not so limited. Also within the scope of this disclosure is an interactive television situation, where the user may be standing or walking or otherwise performing some action (such as cooking, described later) while also viewing content on the content display 200 or an other portable display device.

FIG. 2B shows a content program 250 on the content display 200. In the embodiment shown in FIG. 2B, the content program 250 is a cooking show, and the program includes a host chef cooking a dish involving eggs and other ingredients. While the instant example shows eggs as an exemplary “one or more item” or “one or more physical item” related to the show itself, other items that may be used in a recipe may also be considered as one or more physical items. Further, other types of cooking dishes that do not include eggs may be the subject of the cooking show.

FIG. 2C shows a prompt according to some embodiments. At some predetermined time, the display screen may be provided with a pop-up 255 requesting information from the viewer. The pop-up may show, for example as in FIG. 2C, a message “would you like to order the ingredients on this program?” Such a message may allow the user to order some, or all, items that are relevant to the cooking event shown on the content program 250.

For example, in a situation where the cooking program is a program to cook an eggs benedict, the one or more physical items that may be needed to cook the eggs benedict shown in the program are eggs, butter, Canadian bacon, an English muffin, butter, parsley, lemon juice, salt and cayenne pepper. These correspond to one or more physical items that have a predetermined relationship with the cooking program, as they are the items that are used to cook the recipe shown on the content program. That is, the relationship between the physical items and the content program may be that the items are used in a recipe shown or discussed on the content program.

Further, the list of items may be provided to a user visually, for example on a list provided on the screen or using audio provided through the speaker or other audio component.

As can be appreciated, the items being shown on the content program 250 are digital representations of physical items. Thus, the prompt on the pop-up 255 asking whether the ingredients on the program should be ordered amounts to an offer to order physical items.

As shown in FIG. 2C, the pop-up (e.g., a popup screen) 255 may be superimposed on the cooking program itself and may appear at any point during the content program 250. For example, when the user is viewing the content show during a live viewing, the popup may be stored in a memory either within the content receiver 100 or on an external server (either external server 400 or an additional external server) communicating with the content receiver 100. At the predetermined time, which can be stored within metadata of the content program 250, the popup 255 may appear. The predetermined time may be any predetermined time, including at the beginning of the show, when the chef begins the recipe, or at the end of the show. If the user is viewing the show as a recording or using a pay-per-view or streaming system, the popup 255 may be similarly provided at any predetermined time, similarly to when the content program 250 is being viewed live. The popup 255 may be shown on the content display 200 being superimposed on the content program 250, or may be shown next to the content program 250. The content receiver 100 may also function to temporarily pause the content program 250 to allow the viewer some time to make a decision and take an appropriate action, or the content program 250 may continue while the popup 255 remains on the screen for a predetermined time. After the predetermined time elapses, the user 500 may be able to access the popup 255 and take an appropriate action by rewinding the program, or by accessing the pop-up 255 in a separate menu stored within the content receiver 100 and accessible by the signal transmitter 300.

While FIG. 2C shows the pop-up 255 superimposed on the content display 200 either next to the content program 250 during some portion of the content program 250, this disclosure is not so limited. It is also within the scope of the disclosure where the user 500 may, for example, receive the pop-up 255 at a time where the user 500 makes a decision to record the content program 250 for viewing at a later time or otherwise identifies the content program 250 as a program that the user intends to view at its scheduled air time. This may be particularly advantageous where, for example, a user may be able to receive the items for the program before intending to actually watch the content program. Thus, the user may be able to interactively follow the steps or recipe shown in the content program using the actual items described in the content program when viewing the content program for the first time.

For example, the user may be provided with the offer to order the physical items at a time where he selects to record a show. As a nonlimiting example, a user may be searching a television guide provided by the content provider or other provider and choose a particular content program 250 to be recorded or otherwise to take action to identify and/or mark the content program 250 to be played back at some time in the future, for example at a time determined by a user or at the content program's scheduled air time. At the time that the content program 250 is chosen to be recorded or otherwise marked, the pop-up 255 may be provided in a manner similar to that described by FIG. 2C, though on or near the guide screen instead of on or near the content program 250, and the user may then follow similar steps to make a decision whether or not to order the physical items, as further described below.

In embodiments where the content program 250 is a cooking program, a recipe including all of the ingredients, amounts, and steps may also be shown on the content display 200 at a predetermined time, or may be available in a separate menu stored within the content receiver 100 or on an external server and accessible by the signal transmitter 300.

The one or more items that have the predetermined relationship with the content program may be stored with the content program 250 in a memory within the content receiver, on an external server such as external server 400 or some other external server, or on the internet or other network capable of storing such information. For example, the items and the recipe may be provided as metadata by the author of the content program and/or the content provider, and thus can be stored with the content program itself. In some embodiments, the author of the content program will input the items and recipe as metadata, which can then be stored with the content program and accessible on demand. In other embodiments, the content provider of the programming, the station broadcasting the programming, the producer of the programming or the like, may undertake to review the content program and manually input, as metadata, the items and recipe to be stored with the content program itself and similarly to be accessible on demand. In some embodiments, software to automatically parse the content show for verbal and/or visual cues (e.g., a chef listing the ingredients, or a visualization of particular ingredients) may be used to automatically create a list of items and/or a recipe to be included in the metadata to be stored with the content program itself and similarly to be accessible on demand, thus improving the efficiency of inputting the requisite data and avoiding the need for intervention by a program manager or network operator.

After the pop-up 255 is shown at FIG. 2C, the content receiver 100 awaits receipt of a digital signal for a predetermined time. As shown in FIG. 2D, the digital signal may be provided in the form of a remote control signal transmitter 300 utilized by the user. Once the user confirms to order the ingredients on the program (e.g., responds “yes” to the pop-up 255 of FIG. 2C), the content receiver 100 acknowledges receipt of the digital signal. This amounts to a confirmation from the user to accept the offer to order the physical items.

Optionally as shown in FIG. 2D, a “confirm” option 260 is displayed on the content display (screen) 200, where the user may have the option to finally confirm to place the order. The content display 200 may also include a “settings” screen 270 where the user may be able to view or modify, for example, the items and/or amounts of items to be purchased in the order, the delivery time/date, the preferred vendor, and so forth. This may allow for improved utility and efficiency when, for example, the user may already have some ingredients and only wants to order specific ingredients, or when the user wants to make a larger or smaller serving than what may otherwise be assumed by the recipe.

In a situation where the user does not modify the settings as shown in FIG. 2D, the content receiver 100 will transmit, to the external server 400, a request to place an order using the predetermined list of items. The transmission may occur using TCP/IP protocol or other methods.

For example, once the user confirms the order request for any or all of the physical items provided in the recipe and/or on the list, the content receiver 100 transmits the order request to the external server 400, which is accessible to and/or affiliated with a vendor that may be able to fulfill the order request.

The external server 400 may be controlled by the vendor. The external server 400 may also be controlled by the content provider, or by a third party distinct from both the vendor and the content provider, provided that the external server is capable of communicating with the vendor or a server of the vendor to fulfill the order.

In some embodiments, the number of physical items requested by the viewer is at least two, for example at least 3, at least 5, or from 2 to 30, from 3 to 20 or from 5 to 10. In other embodiments, only one physical item is requested, and an order can be fulfilled accordingly.

The order may be fulfilled at any vendor, for example, a supermarket of the user's choice which can be a supermarket known by the content receiver 100 to be within a delivery range of the user's home, or for any location that is preselected by a user as a preferred vendor. The order may be fulfilled using stock held by the vendor or otherwise may be fulfilled by the vendor acquiring the items from an affiliated third party at or after the time of the offer request.

According to some embodiments, the system described herein may interact directly with an application (“app”) or website belonging to the preferred vendor and may automatically input the items, delivery location, delivery date and the like by communicating with the external server 400 on the vendor's side and using the vendor's preferred systems. In some embodiments, the vendor may have a separate system and external server configured to receive, directly from the content provider, an order that can later be processed on the vendor's side.

Fulfillment of the order may occur by the vendor providing the physical items to the user either by delivery at the user's home using a mail or courier service operated by the vendor or by a third party. Fulfillment also may occur by the physical items being left at a predetermined location, such as for “store pick-up,” at a store operated by or controlled by the vendor, or at some other predetermined location to be picked up by the user or other interested party.

FIG. 3A shows another non-limiting exemplary embodiment of the instant disclosure. Similarly to FIG. 2A, FIG. 3A includes a diagram of user 500 sitting, for example, on a chair 550 in a room. The user is able to watch content on a television (an exemplary content display 200), the content display being connected to a DVR (the exemplary content receiver 100). The user has access to a remote (an exemplary signal transmitter 300).

FIG. 3B shows a content program 250 on the content display 200 similarly to FIG. 2B.

FIG. 3C shows the content program 250 on the content display 200. At a predetermined time similar to the predetermined time of the pop-up 255 shown in FIG. 2C, a code 275 such as a quick response (QR) code or other type of matrix code is provided on the display screen. As with the embodiment of FIG. 2C, this may occur at some predetermined time during the viewing of the show, or may also be provided at a time where the user chooses to record the show. The code 275 may remain on the screen for a predetermined time, and may disappear whether or not the user has taken any action to read the code. The code may be available at an alternative time after expiration of the display of the code, for example by rewinding the content program 250 to the time at which the code 275 was displayed, or by the user accessing a separate menu.

In examples where the code 275 is a QR code, the QR code may be readable by a QR readable device, such as the user's smartphone shown in FIG. 3D, a laptop, a camera or a tablet, or any other handheld or desktop device. The QR code will include or source to metadata similarly to the metadata stored with reference to the popup 255 in FIG. 2C.

The user may use a smartphone, which is a form of signal transmitter 300, to read the QR code. Upon reading of the QR code, the user's smartphone may include a prompt similar to that shown in FIG. 2C. That is, as shown in FIG. 3D, the prompt 355 “would you like to order ingredients?” may appear on the user's smartphone. The user may have options to confirm 360 or view and modify settings 370 in a manner similar to that described with respect to FIG. 2D.

Once the items and other settings have been confirmed, or once the request for the items has been confirmed in an event that the user chooses to proceed with preselected settings without modifying them, the user's smartphone (a signal transmitter 300) may communicate directly with the external server 400 to order the items. Similarly to the embodiment of FIG. 2A-2D, in this embodiment, the system described herein may interact directly with an application (“app”) or website belonging to the preferred vendor (which, in this case may be stored in the user's smartphone) and may automatically input the items, delivery location, delivery date and the like by communicating with the external server 400 on the vendor's side and using the vendor's preferred criteria. In some embodiments, the vendor may have a separate system and external server configured to receive, directly from the content provider, an order that can later be processed on the vendor's side.

In some embodiments, once the order is confirmed, the user's smartphone may redirect to the vendor's app on the smartphone with some or all of the necessary criteria such as items, delivery date and delivery location pre-filled, which may allow the user to make further changes or confirmations using the vendor's app.

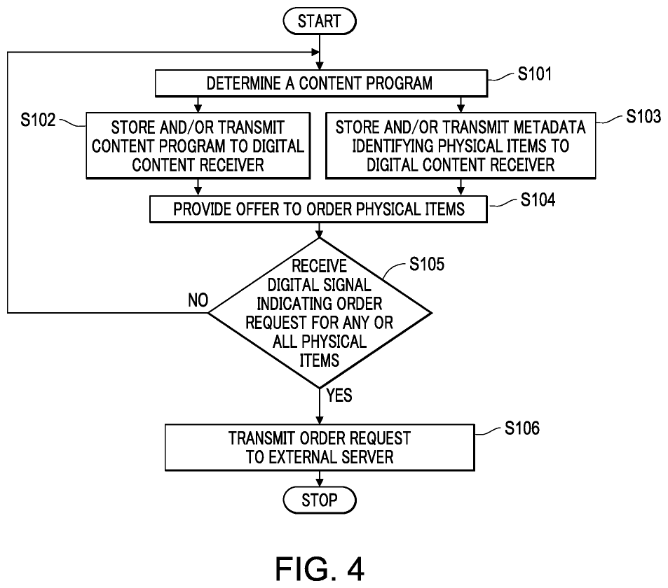

FIG. 4 shows a flow chart of the methods described with reference to the embodiments described above. In a step S101, a content program may be determined. For example, a content program 250 may be prepared by a content provider or network, and ultimately entered to a television schedule, an on-demand platform, or other streaming service.

In a step S102, the method may storing and/or transmitting the content program to a digital content receiver. For example, the content program 250 as shown in FIGS. 2B, 2C, 3B and 3C may be transmitted from a content provider or other entity to the content receiver 100. In step S103, which may be performed concurrently, before or after step S102, metadata identifying one or more physical items can be stored and/or transmitted to the digital content receiver in a way similar to the content program in S102.

The method further includes a step S103 of providing an offer to a user to order one or more physical items. This may be in the form of a popup (such as popup 255 in FIG. 2D or 3D, or by any other notification.

The method then checks to determine if a signal, for example a digital signal, has been received indicating a user's intent to order any or all of the physical items listed in the offer. If this step, S105, indicates that no offer is received, the method may then return to step S101, where a new content program is determined, or may otherwise return to any other earlier step in the method. For example, another offer at S104 may be provided at a later time.

If the digital signal is received in S105, the method further includes a step S106 of transmitting the order request to the external server, after which time it may be fulfilled.

Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the presently described embodiments.

For example, while the embodiments described above refer generally to a specific example of a cooking program and ordering items for a recipe displayed in the cooking program, the instant disclosure is not so limited. The program may be any type of program where a sense of interactivity is desirable. As another nonlimiting example, when watching a home improvement show, a viewer may be interested in learning the techniques presented in the show to ultimately be able to build or renovate a home or portion thereof in a similar manner. In such a case, the viewer may be prompted to order items relevant to the show, so as to complete a building project.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a non-transitory computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

In the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the system and method described herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, the subject matter of this application illustratively disclosed herein suitably may be practiced in the absence of any element(s) that are not specifically disclosed herein.

The terminology used in this application is for the purpose of describing particular embodiments only and is not intended to be limiting of embodiments of the disclosure. As used herein, the singular forms “a”, “an” and “the” are intended to include the plural forms as well, unless the context clearly indicates otherwise. It will be further understood that the terms “has,” “have,” “having,” “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements are intended to include any structure, material, or act for performing the function in combination with other claimed elements as specifically claimed. The explicit description of the present disclosure has been presented for purposes of illustration and description, but is not intended to be exhaustive or limited to embodiments of the disclosure in the form explicitly disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated.

The following claims are in no way intended to limit the scope of embodiments to the specific embodiments described herein.

1. A computer-implemented method of ordering one or more physical items having a predetermined relationship with a content program, the method comprising:
storing and/or transmitting the content program and metadata identifying the one or more physical items to a digital content receiver;
instructing the digital content receiver to display the content program on a display screen;
providing an offer to order the one or more physical items to a content consumer in a visual and/or audio manner, the offer relating to content instructed to be displayed on the display screen, wherein the providing the offer to order the one or more physical items occurs at a time that the content consumer takes action to mark the content program for viewing and before any part of the content program is viewed by the content consumer for a first time;
receiving an order request for any or all of one or more physical items in response to the offer,
wherein the order request is initiated by a digital signal from a signal transmitter that is sent to and received by the digital content receiver; and
transmitting the order request to an external server accessible to a vendor of the physical items.

2. The method according to claim 1, wherein the one or more physical items are graphically represented in the content program.

3. The method according to claim 1, wherein the digital signal is a signal from a remote control, and the transmitting the order request is performed by a hardware processor within a digital video recorder.

4. (canceled)

5. The method according to claim 1, wherein the method further includes providing a QR code on the display screen, and wherein the digital signal is received from a handheld device that reads the QR code.

6. The method according to claim 1, further comprising providing the one or more physical items to the content consumer initiating the order request in a manner determined by the content consumer when placing the order request.

7. The method according to claim 6, wherein the one or more physical items are to be delivered by mail, courier, or made available for pickup at a predetermined location.

8. (canceled)

9. The method according to claim 6, wherein the external server is controlled by the vendor.

10. The method according to claim 6, wherein the external server is controlled by a content provider that provides the content program.

11. The method according to claim 6, wherein the one or more physical items comprises at least two physical items.

12. (canceled)

13. The method according to claim 1, wherein the physical items are cooking ingredients.

14. A system for ordering one or more physical items having a predetermined relationship with a content program, comprising:
one or more hardware processors programmed to:
store and/or transmit the content program and metadata identifying the one or more physical items to a memory provided within a digital content receiver;
instruct the digital content receiver to display the content program on a display screen;
provide an offer to order the one or more physical items to a content consumer in a visual and/or audio manner, the offer relating to content instructed to be displayed on the display screen, wherein the providing the offer to order the one or more physical items occurs at a time that the content consumer takes action to mark the content program for viewing and before any part of the content program is viewed for a first time by the content consumer;
receive an order request for any or all of the one or more physical items in response to the offer,
wherein the order request is initiated by a digital signal from a signal transmitter that is sent to and received by the digital content receiver; and
transmit the order request to an external server accessible to a vendor of the physical items.

15. The system according to claim 14, further comprising the external server, wherein the external server is controlled by the vendor, and the external server provides information to the vendor for fulfilling the order request.

16. The system according to claim 14, further comprising the display screen, the display screen displaying a video component of the content program.

17. The system according to claim 16, wherein the display screen displays a list of the one or more physical items superimposed on the video component of the content program.

18. The system according to claim 16, further comprising a digital video recorder, wherein the digital video recorder comprises one of the one or more hardware processors.

19. The system according to claim 18, further comprising a handheld device comprising at least one other of the one or more hardware processors.

20. A non-transitory, computer readable storage medium having stored instructions therein which, when executed by one or more processors of an electronic device, cause the one or more processors to:
store and/or transmit a content program and metadata identifying the one or more physical items to a memory provided within a digital content receiver;
instruct the digital content receiver to display the content program on a display screen;
provide an offer to order the one or more physical items to a content consumer in a visual and/or audio manner, the offer relating to content instructed to be displayed on the display screen, wherein the providing the offer to order the one or more physical items occurs at a time that the content consumer takes action to mark the content program for viewing and before any part of the content program is viewed for a first time by the content consumer;
receive an order request for any or all of the one or more physical items in response to the offer,
wherein the order request is initiated by a digital signal from a signal transmitter that is sent to and received by the digital content receiver; and
transmit the order request to an external server accessible to a vendor of the physical items.

21. The method according to claim 1, wherein the marking the content program for viewing includes instructing a digital video recorder to record the content program.

22. The method according to claim 1, further comprising generating an interface for display on the display screen.

23. The method according to claim 1, wherein the content consumer takes action to mark the content program for viewing at a time that the content consumer is viewing a searching guide identifying the content program and before a scheduled air time of the program.
